(19) United States
(12) Patent Application Publication
(10) Pub. No.: US 2025/0350114 A1
(43) Pub. Date: Nov. 13, 2025

(54) METHOD FOR VALIDATING AN ELECTRICAL ENERGY SYSTEM

(71) Applicant: Viessmann Climate Solutions SE, Allendorf (DE)

(72) Inventors: Moritz LAUSTER, Berlin (DE); Max PRITZKOLEIT, Berlin (DE); Viktor KISNER, Berlin (DE); Jens-Uwe SÖHNER, Teltow (DE)

(73) Assignee: Viessmann Climate Solutions SE, Allendorf (DE)

(21) Appl. No.: 18/870,421

(22) PCT Filed: May 3, 2023
(86) PCT No.: PCT/EP2023/061600

§ 371 Date: Nov. 28, 2024

(30) Foreign Application Priority Data
Jun. 3, 2022 (DE) 10 2022 114 131.4

(51) Int. Cl. H02J 3/00; H02J 13/00

(52) U.S. Cl. CPC H02J 3/0012; H02J 13/00002; H02J 2203/10; H02J 2203/20; H02J 2310/12

(57) ABSTRACT

A method validates an electrical energy system in a building. The method includes providing a connection pattern of the electrical energy system. The connection pattern describes an arrangement of a plurality of components of the electrical energy system and the relative position and connections of the components. The method further includes setting the electrical energy system into a first operating state by driving at least one component. At least one measurement value is acquired in the first operating state. A plausibility check is carried out as a function of the at least one measurement value and the provided connection pattern. A signal is output as a function of the result of the plausibility check.

### CROSS REFERENCE TO RELATED APPLICATIONS

This application claims priority to German Application Number DE 10 2022 114 131.4, filed Jun. 3, 2022, and International Application Number PCT/EP2023/061600, filed May 3, 2023, the entire disclosures of which are incorporated herein by reference.

### TECHNICAL FIELD

The present disclosure relates to a method for validating an electrical energy system in a building and to an electrical system. In particular, an electrical connection pattern of the electrical energy system is to be checked.

### BACKGROUND

German patent application No. DE 10 2018 206 214 describes a method for operating an energy supply system in a building. The system comprises a regulating or control device which receives measurement values and regulates and/or controls the operating state of the system. Such a regulating or control device is also referred to as EMS (“Energy Management System”) or HEMS (“Home Energy Management System”).

### SUMMARY

If an electrical energy system is newly installed in a building or changes are made to an existing energy system, an electrical connection pattern of the energy system must be configured in a control device of the energy system when the energy system is (re-) commissioned. An incomplete or faulty connection pattern can lead to faults during the operation of the electrical energy system. Therefore, the connection pattern generally has to be checked, which in practice, however, can be very complex and in part also susceptible to faults. Therefore, there is a need to carry out an automatic or guided validation of an electrical energy system.

The present disclosure is based on the problem of overcoming the problems known in the prior art and of specifying a method for validating an electrical energy system which is improved over the prior art. Furthermore, an electrical energy system which is improved over the prior art and has a control device (HEMS) is to be provided.

The control device can acquire or regulate and/or control operating states or operating parameters of the electrical energy system or individual components of the energy system. Depending on the function, the control device can also be considered as a feedback-control device. In the following, the control device is also referred to as “HEMS.”

According to the disclosure, the problem is solved by a method for validating an electrical energy system and by an electrical energy system according to independent claims. Preferred embodiments of the present disclosure are set forth in the dependent claims, the attached drawings, and the following description of exemplary embodiments.

One goal of the method is to automatically determine the positioning of the components in the electrical energy system or in the electrical connection pattern of the energy system by optimized test methods. Furthermore, a deviation between an actually installed connection pattern and a provided connection pattern or a connection pattern selected by a user is to be detected.

A connection pattern describes an arrangement of various components of the electrical energy system and the relative position and connections thereof with one another. Graphically, the connection pattern can be shown, in particular schematically, by corresponding symbols for components and lines for connections.

Exemplary components of the energy system are electrical generators, such as, for example, a PV system and/or a fuel cell, which provide electrical energy. A PV system or fuel cell typically has a (controllable) inverter in order to provide alternating current to a domestic network of the building.

Furthermore, the energy system can have controllable loads, such as, for example, a heat pump, an electrical heating device and/or an electric vehicle or the charging station thereof, which is also referred to as wallbox. The electrical heating device can be, for example, a heating rod of the heat pump for heating water. The heating rod can support the heat pump, in particular at very low outside temperatures. The term “controllable load” also comprises loads which are merely controllable.

An electrical energy store which is set up in a stationary manner in the building and which has, for example, a battery or a rechargeable battery can likewise be understood as a controllable load, since the energy store consumes energy during charging and parameters such as time, period, charging power etc. can be determined by the control device HEMS. In addition, the energy store can also be understood or operated as a controllable generator, since it can provide stored energy from the HEMS, in particular as a function of regulating or control signals.

Furthermore, an electrical energy system comprises a plurality of non-controllable loads, such as, for example, electrical domestic appliances, electrical light, and the like. The respective operating state of a non-controllable load cannot be directly influenced by the HEMS.

The electrical lines for electrical current or electrical voltage can be referred to collectively as a domestic network. The connection of loads takes place, for example, via sockets which are connected to the domestic network.

Furthermore, the electrical energy system comprises a grid connection point, via which electrical energy can be drawn from a public grid or locally generated energy can be fed into the public grid. The relative position of the grid connection point in relation to the other components is described by the connection pattern.

In addition, the electrical energy system comprises at least one measuring device, in particular an electrical electricity meter for measuring an electrical current or an energy consumption, a power consumption, an energy generation or a power output. For example, electricity meters can be arranged at the grid connection point and/or at other nodes of the electrical energy system. In particular, for example, the consumption of a controllable load and/or the power generation of a local energy generator (for example PV system) can each be acquired by separate meters. In preferred embodiments, the energy system can have a plurality of measuring devices. In the following description, the terms measuring device, electricity meter and meter can be used synonymously.

The central control device (HEMS) serves for regulating and/or controlling the energy system, in particular the at least one controllable load and/or the at least one energy store and/or the at least one generator.

Furthermore, the control device acquires measurement values of the electricity meters. The control device can also have a human-machine interface via which a user can make inputs and can read outputs. For this purpose, the control device can have a display device and an input device. Alternatively, or additionally, the control device can be connected to a network, with the result that inputs and/or outputs can be made, for example, via an app or a browser or the like on a terminal (for example laptop or smartphone or the like) of the user.

In the following, individual method steps of the method according to the disclosure are described which can be carried out individually, successively, or simultaneously. Not all steps are essential for solving the problem according to the disclosure, with the result that individual steps can also be omitted.

In a first step, a connection pattern of the electrical energy system is provided. The connection pattern can, for example, be provided by the user.

The provision can preferably take place automatically. For example, the HEMS can provide a connection pattern as a function of automatically detected components or output a suggestion to the user who can either accept or reject the suggestion.

According to a preferred embodiment, the provision of the connection pattern can take place interactively with the user. For this purpose, firstly a human-machine interface is started which can have a graphical user interface which is executed, for example, via a browser or an app in a terminal of the user or via a display device of the HEMS. Subsequently, a request can be output to the user to specify the connection pattern by means of an input or a plurality of inputs. The input can take place, for example, by selecting from a list of possible connection patterns and/or interactively and preferably iteratively by answering a series of questions.

In particular, the HEMS can output a series of queries to the user so that the user can make a series of inputs. Here, for example, the presence of concrete components and/or the number thereof and/or the relative arrangement thereof with respect to other components can be queried individually in sequence. As a function of the inputs of the user, a restricted selection of possible connection patterns can then be proposed, or a single suitable connection pattern can be determined. The series of queries can be set up iteratively so that each individual query can have an influence on a following query or selection option.

Subsequently, the HEMS can determine and propose or provide a suitable connection pattern as a function of the inputs of the user.

The inputs of the user can take place, for example, by selecting individual components in displayed lists or graphical interfaces. Furthermore, the user can make a selection from a plurality of provided connection patterns. Here, the HEMS can make a preselection as a function of already detected components in order to facilitate the selection for the user, wherein the HEMS can display a plurality of possible connection patterns.

The automatic detection of components can take place by acquiring at least one signal from at least one component of the electrical energy system. The signal can, for example, be transmitted wirelessly from the component and received by the HEMS. Alternatively, the signal can also be transmitted in a wired manner. For example, the establishment of a plug connection between a control line of a component and the HEMS can be detected automatically.

The HEMS can detect the at least one component preferably on the basis of the acquired signal. In particular, the HEMS detects a type of construction and/or a device type of the component. Furthermore, an operating state of the component can already be acquired in this case.

The validation of the electrical energy system comprises a step of setting the electrical energy system into a first operating state by driving at least one first component. The HEMS then acquires at least one measurement value in the first operating state. The measurement value can in particular be generated by an electricity meter and transmitted to the HEMS. Subsequently, the HEMS carries out a plausibility check as a function of the at least one measurement value and the provided connection pattern. Within the scope of the plausibility check, it is checked whether the acquired measurement value is plausible with the provided circuit pattern.

Driving a component can preferably comprise that a provided power consumption or power output is brought about by the component. This set power consumption or power output can, for example, be acquired by a corresponding change of a measurement value at one of the measuring devices and compared with the provided value. From this, it is possible, inter alia, to determine information about the relative position of the component in comparison with the measuring device and in comparison with other components. Furthermore, the correct functioning of the component and the driving thereof can be validated.

The HEMS outputs a signal as a function of the result of the plausibility check. The signal is, for example, a message which is output to the user, for example via the human-machine interface. The message can indicate whether the connection pattern is plausible or not. The message can therefore be, in particular, a success message or an error message.

According to a preferred embodiment, the step of outputting the signal comprises outputting a message to the user with a suggestion for an alternative connection pattern as a function of the result of the plausibility check, wherein the alternative connection pattern describes a different arrangement of the plurality of components of the electrical energy system and the relative position and connections thereof.

In particular if the plausibility check reveals that the provided connection pattern is not plausible with the acquired measurement value, the suggestion for an alternative, plausible connection pattern can be output. The user can then accept the suggestion by a corresponding input. Subsequently, a renewed validation can preferably be carried out.

The signal can be output in various ways. In particular, the signal can be transmitted in the form of a message to a terminal of a user and/or operator of the energy system. Additionally, or alternatively, the signal can be displayed as an indication on a display device on the HEMS or in the vicinity of the HEMS. Furthermore, additionally or alternatively, the signal can be a regulating signal or control signal which the HEMS can output to a component of the energy system, in particular in order to carry out a regulatory intervention and/or in order to change an operating state of the energy system.

Preferably, the output signal can comprise an error message to a user and/or operator of the energy system. In particular, the error message can be output to a mobile terminal of the user and/or operator. The error message can, for example, indicate that the validation has revealed that the provided connection pattern is not plausible with the acquired measurement values.

The validation can comprise a further step in which the electrical energy system is set into a second operating state by driving the first component and/or by driving a second component, wherein at least one further measurement value is acquired in the second operating state.

The plausibility check can accordingly be carried out as a function of the first measurement value in the first operating state and as a function of the second measurement value in the second operating state. The plausibility of the provided connection pattern can therefore be checked even more precisely, in particular if a plurality of connection patterns are plausible with the measurement value of only the first operating state. As a result, the number of possible plausible connection patterns can be reduced.

A preferred electrical energy system has a controllable load as a first component and a corresponding electricity meter for measuring a consumption of the controllable load. Accordingly, the HEMS can drive the first component by transmitting a power consumption command to the controllable load. The power consumption command can provide a power consumption (or power consumption of the load) equal to zero or greater than zero. A power consumption command equal to zero can also be referred to as a switch-off command.

According to an example, the at least one measurement value can be acquired by receiving the measured consumption of the controllable load from the electricity meter and the plausibility check can be carried out by comparing the measured consumption with the transmitted power consumption command.

A preferred electrical energy system has a controllable electrical energy store and/or generator as a first or second component and a corresponding electricity meter for measuring an output of electrical power of the energy store or generator.

According to an example, the HEMS can drive the first component by transmitting a power output command to the energy store and/or generator. The HEMS acquires the at least one measurement value by receiving the measured output of the energy store and/or generator from the electricity meter and carries out the plausibility check by comparing the measured output with the transmitted power output command.

In a preferred method, the HEMS acquires a first measurement value from a first electricity meter at the grid connection point (NAP), via which electrical energy can be drawn from a public power grid and/or fed into the public power grid. Furthermore, the HEMS can acquire at least one second measurement value from at least one second electricity meter. The at least one second electricity meter measures, for example, a consumption of a controllable load, and/or a power output of an energy store and/or a power output of a generator.

In addition, the HEMS can determine a consumption of non-controllable loads as a function of a difference between the first measurement value and the second measurement value. The plausibility check can accordingly be carried out as a function of the first measurement value, the second measurement value and the provided connection pattern.

According to an example, the method comprises a step of transmitting data from the HEMS to a cloud or a server. The cloud or the server can be arranged geographically remote from the building with the energy system. The data can be stored in the cloud or in a storage device of the server in order to be used, for example, for an evaluation. The cloud or the server can evaluate the data sets, in particular in order to carry out the plausibility check.

As a function of the results of the calculations, a signal can be output by the cloud or the server, for example to the mobile terminal of the user or operator of the energy system. The mobile terminal can receive the signal, in particular, via an Internet connection.

The electrical energy system can further comprise at least one renewable energy source, such as, for example, a photovoltaic system (PV system) or a wind turbine, which is configured to supply the (controllable and non-controllable) loads and the energy store with energy. A photovoltaic system usually has an inverter in order to convert the direct current generated by the PV system into alternating current. The inverter can be controlled, for example, by the HEMS. Furthermore, the PV system can have a separate electricity meter in order to measure the energy generated by the PV system. In particular, part of the generated energy can be used for charging the energy store. Furthermore, energy can be fed from the PV system via the grid connection point into the public power grid. The fed-in energy can preferably be measured via a counter at the grid connection point in order to calculate the remuneration.

The HEMS is preferably configured to carry out some or all of the method steps of the method according to the disclosure described here.

### BRIEF DESCRIPTION OF THE DRAWINGS

Further examples are described in greater detail below on the basis of an exemplary embodiment illustrated in the drawings, but to which the disclosure is not restricted.

In the drawings:

FIG. 1 shows an electrical energy system in a building according to an exemplary embodiment of the disclosure.

FIG. 2 shows three exemplary connection patterns A, B and C.

FIG. 3 shows an electrical energy system in a building according to connection pattern B.

### DESCRIPTION

In the following description of a preferred embodiment of the present disclosure, identical reference signs refer to identical or comparable components.

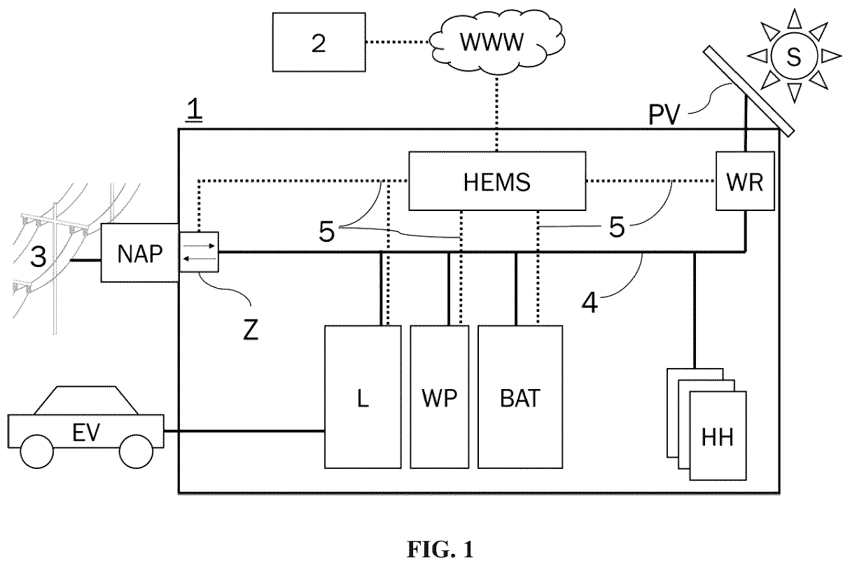

FIG. 1 shows a schematic representation of an exemplary embodiment of an electrical energy system 1 according to the disclosure in a building. The building can be, in particular, a residential building or an office building.

The energy system 1 shown in FIG. 1 comprises a photovoltaic system PV (in the following also abbreviated as PV system), which converts radiant energy from the sun S into electrical energy. Instead of a PV system or in addition to the PV system, the energy system 1 can use other renewable energy sources, such as, for example, a wind turbine and/or a fuel cell.

An inverter WR converts the direct current generated by the PV system into alternating current and outputs this to an internal domestic network 4 of the building. A plurality of non-controllable loads HH, a heat pump WP as a controllable load, a charging station or wallbox L for an electric vehicle EV as a controllable load and an energy store BAT as a controllable load can be supplied with electrical energy via the domestic network 4.

The solid lines symbolize here the power lines of the domestic network 4 of the building. Dotted lines symbolize communication lines 5 for the data traffic, in particular between the loads or generators and the HEMS, which serves as a control device or regulating device. For example, the communication lines 5 transmit control signals, regulating signals and/or measurement signals. The signals serve, for example, for acquiring measurement values and/or for controlling or regulating and/or for the data exchange with a server 2 via a network, for example the Internet WWW, or with a cloud.

The domestic network 4 of the building is connected via a grid connection point NAP to a public power grid 3, which is operated by an energy supply company or grid operator. An electricity meter Z measures the energy consumption (power consumption), which is drawn from the public grid 3 by the domestic network 4, and also the amount of energy (or produced power integrated over time), which is fed into the public grid 3 by the energy system 1.

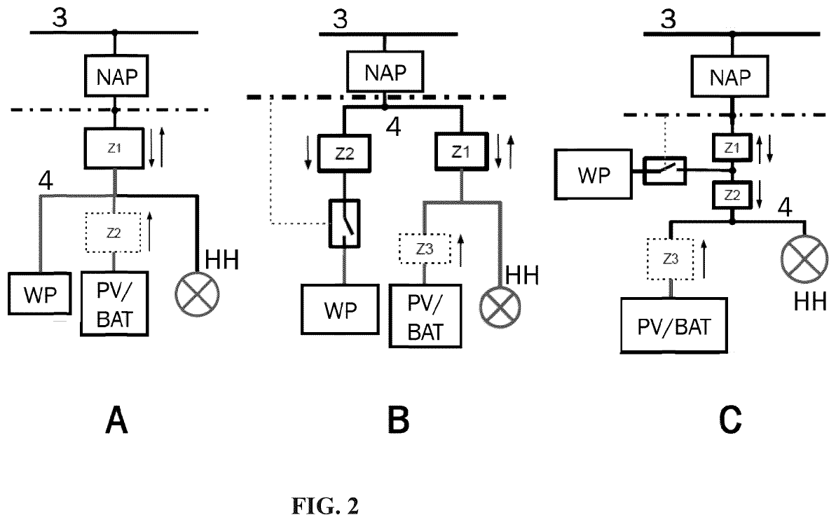

The electricity meter Z can be an intelligent electricity meter, which can be connected to the Internet or an intranet. The regulating or control device HEMS of the energy system 1 can acquire measurement values from the electricity meter Z via the communication lines 5. Furthermore, the energy system 1 can have further meters, not shown in FIG. 1, as shown, for example, in FIG. 2.

The energy store BAT serves for storing electrical energy and can be constructed from a plurality of batteries or rechargeable batteries. The energy store BAT comprises an inverter, not shown, which converts alternating current from the domestic network 4 into direct current for charging the energy store BAT. Furthermore, the inverter can convert direct current from the energy store BAT into alternating current for the domestic network 4.

For charging the energy store BAT with energy from the PV system, a direct and separate power line between PV system and energy store BAT can also be provided, so that a conversion between direct current and alternating current when charging the energy store BAT can be dispensed with. Such a direct current line can also be provided between the energy store BAT and the charging station L.

A further component of the energy system 1 is a further controllable load, shown here by way of example by a heat pump WP. The operation of the heat pump WP can be controlled or regulated by the HEMS. The energy system 1 can also comprise further controllable loads. For example, an electrical heating device can be controlled by the HEMS. The electrical heating device can be in particular a heating rod of the heat pump WP.

Furthermore, a ventilation system and/or an air conditioning system and/or a night store heater can be provided as controllable loads. These are not shown in FIG. 1. The charging station L and the energy store BAT can also be operated as controllable loads.

A plurality of non-controllable loads HH is connected to the domestic network 4 of the building. The non-controllable loads HH are, for example, domestic appliances and/or lighting means or other loads which can be switched on and off by a user or resident of the building. In an office building, a plurality of computers, printers and/or copiers can be present, for example, as non-controllable loads HH.

The HEMS is connected via communication lines 5 to the inverter WR of the PV system, to the heat pump WP, to the energy store BAT, to the electricity meter Z at the grid connection point NAP, to the charging station L and via the Internet WWW to the server 2. Instead of wired communication lines 5, (partially) a wireless communication or a communication by means of optical waveguides can also be provided between the HEMS and the mentioned components of the energy system 1. Furthermore, the energy system 1 can have further electricity meters which measure, for example, the energy generated by the PV system and/or the energy consumed by the non-controllable loads HH.

FIG. 2 shows three exemplary connection patterns A, B and C which each have two electricity meters Z1, Z2, a heat pump WP as a controllable load, a PV system as an energy generator and/or an energy store BAT as a controllable load or controllable energy source and a plurality of non-controllable loads HH. An internal domestic network 4 is connected in each case via a grid connection point NAP to the public power grid 3. The operating states of the heat pump WP and of the PV system and/or of the energy store BAT can be controlled or regulated by the HEMS (not shown).

The first electricity meter Z1 can measure in each case a consumption of electrical energy from the public power grid 3 or a feed of electrical energy into the public power grid 3. The connection patterns B and C each have a third electricity meter Z3 for the PV system or the energy store BAT, which meters a fed-in energy.

When an electrical energy system 1 is commissioned, the connection pattern is to be validated. It is known that the energy system has a heat pump WP, an energy store BAT and a plurality of non-controllable loads HH. This information can be acquired, for example, by querying a user who can make corresponding inputs. Alternatively, the HEMS can automatically acquire at least the presence of the heat pump WP, of the energy store BAT and of the electricity meter Z by corresponding signals. If the HEMS acquires three electricity meters Z1, Z2, Z3, the connection pattern A can be excluded. Therefore, it is only necessary to distinguish between connection patterns B and C.

To validate the arrangement of the components, a first component can now first be driven. For example, the HEMS can output a power output command to the energy store BAT. Both in connection pattern B and in connection pattern C, the HEMS acquires a signal from the meter Z3. However, the signals of the meters Z1 and Z2 depend on the operating state of the heat pump WP. In order to distinguish between connection patterns B and C, the HEMS can output a power input command to the heat pump WP in a next step.

By comparing the measurement values of the meters Z1, Z2 and Z3, it is therefore possible to distinguish between connection patterns B and C. Furthermore, a consumption of the non-controllable loads HH can be calculated and compared with a predefined range in order to validate the plausibility.

In a further step, the heat pump WP can be driven by the HEMS by the HEMS outputting a power input command. As a result, either the meter Z1 (connection pattern A or C) or the meter Z2 (connection pattern B) shows a power input increased by the power of a few kilowatts consumed by the heat pump WP. If only meter Z2 shows the power input of the heat pump, connection patterns A and C can be excluded.

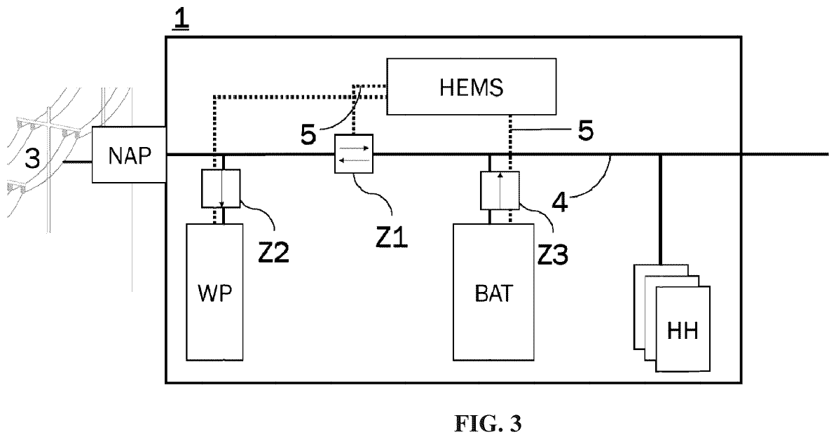

FIG. 3 shows a modification of FIG. 1 according to the connection pattern B with three meters Z1, Z2, Z3, a heat pump WP, an energy store BAT, and a plurality of non-controllable loads.

Preferably, an automatic validation of the connected components of the energy system 1 can be carried out by the HEMS. The HEMS can be implemented here as part of one of the connected components, as a separate functional unit and/or in the cloud or in the server 2.

Before or during the commissioning of the energy system 1 or if a change and re-commissioning of the energy system 1 is carried out, a user can make an input for providing the connection pattern in a method step or a, in particular wireless, transmission of the connection pattern to the HEMS can take place.

The set connection pattern is then checked for its plausibility by means of the validation method according to the disclosure. The method steps can be stored locally in the HEMS or can be transmitted from the cloud or the server 2. Permissible result ranges can also be transmitted via the network WWW and/or a comparison with result ranges which are stored in a database in the cloud or in the server 2 can be carried out in that measurement values are transmitted from the HEMS via the network WWW to the cloud or the server 2.

In a step of the method, the validation method can be initialized by the HEMS. In this case, for example, control commands can be transmitted to the components and a monitoring and analysis of the resulting measurement values can be carried out.

In particular, a driven component can transmit a feedback to the HEMS as to which operating state is presently present and/or which power is presently being generated or consumed. Furthermore, it is possible to acquire the amount of energy which has previously been generated and/or consumed during the validation method, whether the commands received from the HEMS are or have been executed or which measure has been executed or which power and/or energy consumption has resulted. This and further information can either be transmitted from the respective component to the HEMS and/or the HEMS calculates this information from the acquired measurement values.

In order to validate the connection pattern, the HEMS can in particular generate artificial demand requirements (power consumption or power output). These commands can comprise, for example: a power requirement and/or deregulation requirement to a generator or load or store BAT. transmitting an SG Ready signal to a controllable load and optionally repeating the transmission of the control command.

An exemplary validation method for an energy system with a PV system comprises in particular a step of transmitting weather data or data relating to a radiation intensity, for example from the cloud or acquired by local sensors, a step of calculating a predicted power of the PV system over a predefined time interval and a step of comparing the power actually output over the time interval with the calculated power.

An exemplary validation method for checking an electricity meter for the consumption of non-controllable loads (domestic loads) comprises in particular a step of determining whether a controllable load is connected to the domestic electricity in the connection pattern, see, for example, load HH and heat pump WP in connection pattern A behind counter Z1. By driving the heat pump WP in connection pattern A and acquiring the measurement value of counter Z1, the consumption of the non-controllable loads can then also be determined accordingly. By switching off and switching on the heat pump WP in connection pattern A, conclusions can be drawn as to the position of the counter Z1.

An exemplary validation method for validating a meter for a heat pump WP according to § 14a EnWG, see, for example, Z2 in connection pattern B or Z1 in connection pattern C comprises in particular the transmission of a power consumption command to the heat pump WP and the reading out of the meter and comparison of the consumed power with the power consumption command.

The validation method can, for example, determine counters which are dependent on one another. Such are, for example, sequentially connected cascades of meters, such as Z1 and Z2 in connection pattern A, Z1 and Z3 in connection pattern B and Z1 to Z3 in connection pattern C. In such a method, the individual values of the individual counters Z1 to Z3 are determined and compared with one another in order to determine the order of the counters.

If the connection pattern has been successfully validated, the electrical energy system 1 can be commissioned. If, by contrast, the validation has not been successful, an error message can be output which can additionally have a proposal for a determined actual connection pattern. The user or installer of the energy system can then have the possibility of confirming the newly determined connection pattern, with the result that the energy system 1 can be commissioned with the actual connection pattern.

The features disclosed in the above description, the claims and the drawings can be significant both individually and in any desired combination for the realization of the disclosure in its various embodiments.

What is claimed is:

1. A method for validating an electrical energy system in a building, comprising:
providing a connection pattern of the electrical energy system, wherein the connection pattern describes an arrangement of a plurality of components of the electrical energy system and a relative position and connections of respective components of the plurality of components;
setting the electrical energy system into a first operating state by driving at least one first component;
acquiring at least one measurement value in the first operating state;
carrying out a plausibility check as a function of the at least one measurement value and the provided connection pattern; and
outputting a signal as a function of a result of the plausibility check.

2. The method according to claim 1, further comprising:
setting the electrical energy system into a second operating state by driving the at least one first component and/or by driving a second component;
acquiring at least one measurement value in the second operating state; and
carrying out the plausibility check as a function of the measurement values in the first and second operating states and the provided connection pattern.

3. The method according to claim 1, wherein providing the connection pattern comprises:
starting a human-machine interface;
outputting a request to a user to specify the connection pattern by means of an input; and
providing the connection pattern as a function of the input of the user.

4. The method according to claim 1, further comprising:
acquiring at least one signal from at least one component of the electrical energy system;
identifying the at least one component based on the acquired at least one signal; and
outputting a plurality of possible connection patterns.

5. The method according to claim 1, wherein the electrical energy system has a controllable load as a first component and an electricity meter for measuring a consumption of the controllable load, the method further comprising:
driving the first component by transmitting a power consumption command to the controllable load;
acquiring the at least one measurement value by receiving the measured consumption of the controllable load from the electricity meter; and
carrying out the plausibility check by comparing the measured consumption with the transmitted power consumption command.

6. The method according to claim 1, wherein the electrical energy system has, as a first component, a controllable electrical energy store and/or a generator and an electricity meter for measuring an output of electrical power of the controllable electrical energy store or the generator, the method comprising:
driving the first component by transmitting a power output command to the controllable electrical energy store and/or the generator;
acquiring the at least one measurement value by receiving the measured output of the controllable electrical energy store and/or the generator from the electricity meter; and
carrying out the plausibility check by comparing the measured output with the transmitted power output command.

7. The method according to claim 1, wherein:
a first measurement value is acquired by a first electricity meter at a grid connection point, via which electrical energy can be drawn from a public power grid and/or fed into the public power grid;
a second measurement value is acquired by a second electricity meter, which:
measures a consumption of a controllable load; or
measures an output of an energy store; or
measures an output of a generator; and
a consumption of non-controllable loads is determined as a function of a difference between the first and second measurement values; and
carrying out the plausibility check as a function of the first measurement value, the second measurement value and the provided connection pattern.

8. The method according to claim 1, wherein outputting the signal comprises:
outputting a message to a user with a suggestion for an alternative connection pattern as a function of the result of the plausibility check, wherein the alternative connection pattern describes a different arrangement of the plurality of components of the electrical energy system and the relative position and connections of the respective components of the plurality of components.

9. An electrical energy system in a building, comprising:
a grid connection point, via which electrical energy can be drawn from a public power grid and/or fed into the public power grid;
a plurality of non-controllable loads;
a controllable load;
an energy store and/or a generator;
an electricity meter for measuring a consumption and/or an output electrical power; and
a control device for regulating and/or controlling the controllable load and/or the energy store and/or the generator,
wherein the control device is configured to:
provide a connection pattern of the electrical energy system, wherein the connection pattern describes an arrangement of the grid connection point, the plurality of non-controllable loads, the controllable load, the energy store and/or the generator and a relative position and connections respectively of the plurality of non-controllable loads, the controllable load, the energy store and/or the generator;
transmit a power consumption or power output command to the controllable load and/or the energy store and/or the generator and thereby set the electrical energy system into a first operating state;
receive a measurement value of the consumption or an output electrical power from the electricity meter;
carry out a plausibility check by comparing the measured consumption with the power consumption command or by comparing the measured power output with the power output command as a function of the provided connection pattern; and
output a signal as a function of a result of the plausibility check.

10. The electrical energy system according to claim 9, further comprising:
a heat pump as a controllable load; and/or
an electrical device for heating water as a controllable load; and/or
an electrical energy store as a controllable load and/or as a controllable generator.
